(19) United States
(12) Patent Application Publication
(10) Pub. No.: US 2002/0154753 A1
(43) Pub. Date: Oct. 24, 2002

(54) User control of telephone switch through an HTTP client application

(76) Inventors: Robert David Schofield, Amersfoort (NL); Magdalena Van Veen, Hilversum (NL)

Correspondence Address: c/o PHILIPS ELECTRONICS CORPORATION, NORTH AMERICA CORPORATION, Intellectual Property Department, 580 White Plains Road, Tarrytown, NY, 10591, US

(21) Appl. No.: 10/040,172

(22) Filed: Oct. 23, 2001

(30) Foreign Application Priority Data
Oct. 27, 2000 (EP) 00203743.0

(51) Int. Cl. H04M 3/42; G06F 9/46

(52) U.S. Cl. 379/201.03; 709/312

(57) ABSTRACT

A telecommunication system comprising a telephone switch, a telephone, a web server and a browser allows the user to control the interaction between the telephone and the telephone switch by interacting with a web page. The web page is provided by the web server based on information obtained from the control application and is based on the operation and features of the telephone switch. The web server provides the control information to the telephone switch through a control application. This allows the communication system to use regular telephone without any features while giving the user access to features through a standard, telephone switch independent user interface in the form of a web page displayed by the browser.

The present invention relates to a communication system comprising a telephone, a telephone switch operative to interact with the telephone and provide a control function to a user of the telephone and to a telephone for use in such a communication system and to telephone switch for use in such a communication system.

Such a system is known from the public switched network where a telephone switch provides a control function to a user of a telephone by using DTMF tones originating from the telephone to control the telephone switch. It is for instance possible for the user to forward telephone calls to a different telephone or to request information about his account by transferring predefined DTMF tones to the telephone switch.

This however requires the user to lookup or memorize the various control functions and the associated DTMF codes. The number and complexity of control functions in a modern telephone switch make it difficult for the user to access these functions through the use of DTMF tones. This problem is alleviated in state of the art communication systems in that telephones with a graphical interface are used where the user can control the telephone switch by selecting a choice from a menu. The telephone then translates the choice into the appropriate control commands for the telephone switch and transfers these control commands through a control channel to the telephone switch.

A disadvantage such a communication system is that a plain telephone does no longer give the user access to all the available functions.

The object of the present invention is to provide a communication system that allows the use of plain telephones while providing access to all functions of the telephone switch through an easy to use graphical interface.

To achieve this objective the present invention is characterized in that the communication system comprises a web server connected to the telephone switch, where the web server is operative to provide the control function to the user of the telephone via an HTTP client application connected to the web server.

Many users of a telephone that is connected to a telephone switch with extensive features also have an HTTP client application in the form of a browser available. The browser can access a web server. The web server by use of an appropriate control application in turn can access the telephone switch and thus a control channel between the user and the telephone switch is established. The web server can provide information that the browser can display. The user can select an item from a user menu, complete a form or operate buttons. The web server control application evaluates the control function desired by the user and instructs the telephone switch accordingly. The control commands for the telephone switch can be specific for the particular switch the web server is connected to. The use of the browser however allows the presentation of the user menu or forms in a consistent universal format independent from a particular telephone switch.

Even though a plain telephone is used the user can control numerous and complex functions provided by the telephone switch.

An embodiment of the communication system according to the present invention is characterized in that the telephone comprises the browser.

The combination of a plain telephone with the browser allows the telephone to be used with all communication systems according to the present invention. Compared to a state of the art telephone with integrated graphical user interface the telephone with an integrated browser is completely independent of the telephone switch and of the web server it is connected to. The browser can display the web pages provided by the web server, regardless of the content of the web page. In the communication system according to the present invention the telephone has no knowledge of any of the features or control commands of the telephone switch.

The present invention will now be described based on figures.

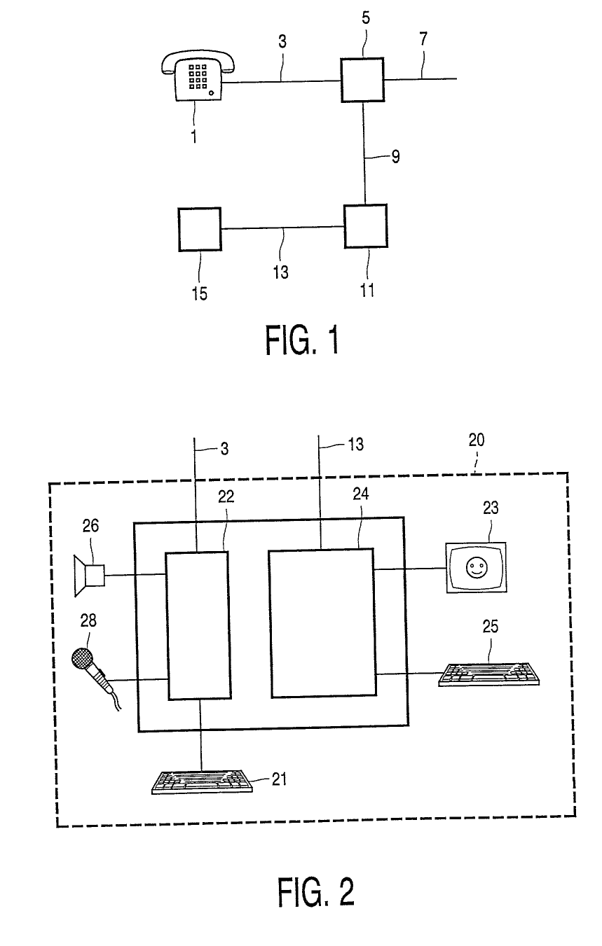

FIG. 1 shows the communication system according to the present invention.

FIG. 2 shows a telephone according to the present invention.

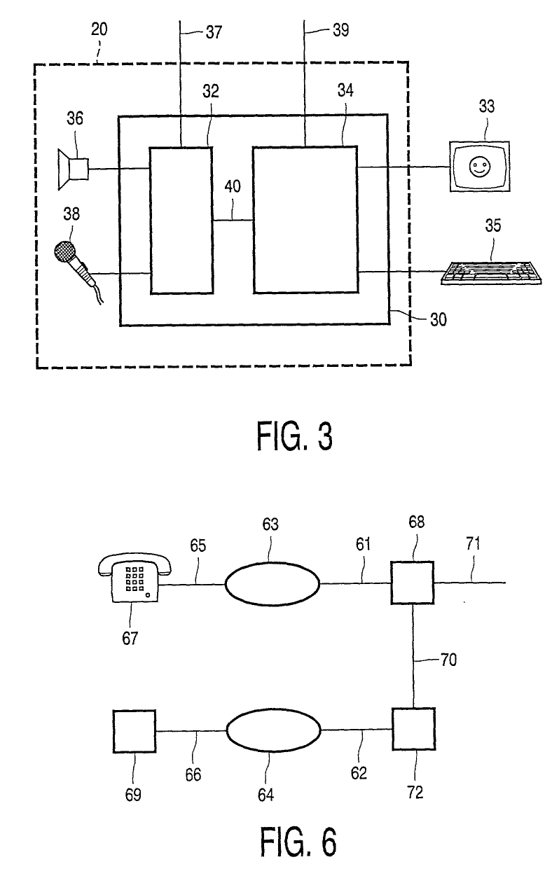

FIG. 3 shows a telephone according to the present invention where the browser is used both for control of the telephone switch and the plain telephone functions

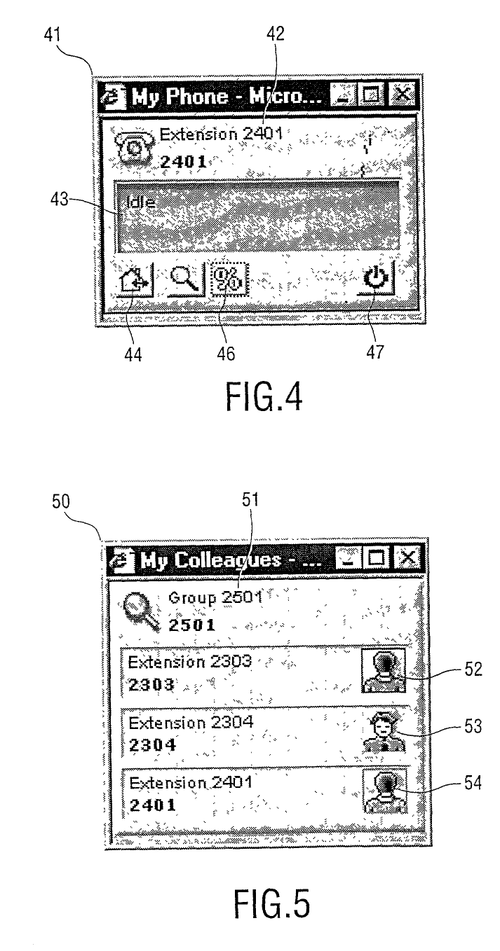

FIG. 4 shows a web page to control the telephone switch.

FIG. 5 shows a web page to retrieve information from the telephone switch.

FIG. 6 shows the communication system according to the present invention where control of the telephone switch is provided to a plain telephone located in a remote location.

FIG. 1 shows the communication system according to the present invention.

A telephone 1 has the normal functionality of a regular telephone, i.e. voice transmission and signaling to establish and drop a connection. The telephone 1 is connected to a telephone switch 5 through a transmission medium 3. This transmission medium can be analog as used in POTS (Plain Old Telephone System) or digital as used in ISDN (Integrated Services Digital Network). The telephone switch 5 can establish connections between the telephone 1 and other telephones, either directly connected to the telephone switch 5 or connected through an outside line 7 through which the telephone switch is connected to the PSTN (Public Switched Telephone Network). The telephone switch can be controlled by a web server 11 that is connected to the telephone switch through a network connection 9. The web server 11 has a control application that can send control commands to the telephone switch 5 to configure the telephone switch, to control the telephone switch or to retrieve information from the telephone switch.

A browser 15 is provided for the user. The browser is connected to the web server through a connection 13.

The user can access the web server 11 through the browser 15. The web server provides an address, for instance a URL (Uniform Resource Locater) where a web page can be found to the browser 15. The browser 15 then retrieves that web page from the specified address and displays the contents of the web page. The web page can contain a menu or buttons or a form or any combination thereof. The content of the web page is based on the available features and operation of the telephone switch 5 and formatted to be displayed by the browser by the web server. When the user provides information to the web server 11 by operating a button, selecting an item from a menu, or by completing a form, the web server 11 transfers this information to a control application that, based on the received information, send the appropriate control commands to the telephone switch 5.

For instance, to initiate a conference call the user selects a web page on the web server that contains a form with entries for the telephone numbers of the participants and a button to initiate the conference call. The web server 11 receives this information as completed on the web page and passes the information to the control application. The control application in turn then instructs the telephone switch 5 to establish calls to all the participants, including the initiator of the conference call, and to configure the established calls into one conference call. The user does not need to use the telephone 1 to provide all this information. After completing the web page the user can wait for his telephone 1 to ring and by answering he will be part of the conference call.

If the browser 15 is connected to the web server 11 via a network, the web server 11 that is associated with the telephone switch 5 does not need to be the only web server.

Since the browser is a standard web browser without any special application related features it can still be used as a general purpose browser to access other servers accessible through the network.

The web server 11 can be accessed by different browsers on the network. This allows the communication system to be configured in such a way that the web page displayed by the browser is associated with a particular user or with a particular telephone.

If the web page is associated with a particular user, the user can log out from one browser and move to another browser and log in. The web page is associated with the user and the communication system now knows where the user is and can reconfigure the telephone switch so that a nearby phone is functioning as the extension of the user. All calls to the user's extension can be routed to the nearby phone.

If the browser is associated with a particular telephone the communication system knows exactly to which telephone the calls for the user that logged in via the browser must be routed.

If the web page is associated with the telephone the user can log in through the web page and identify himself. The telephone switch now knows that the user is not at his own extension but at a different extension and can route the calls to the user the different extension.

Security can be added to the system by allowing certain web pages only to be accessed from certain browsers. This way one can prevent that a particular user uses a particular telephone.

FIG. 2 shows a telephone according to the present invention.

The telephone 20 comprises a speaker 26, a microphone 28, a keypad 21, and a regular electronic telephone circuit 22. The electronic telephone circuit 22 to interface the speaker 26, the microphone 28 and the keypad 21 to a telephone line 3 is very well known from the prior art and differs by no means from this. The telephone 20 further comprises a processing unit 24 that can run a browser program. The processing unit 24 displays information on a display 23 and receives input from the user from an input unit 25. The input unit 25 can be based on voice recognition, touch screen technology or a keyboard. The processing unit processes the web page information received from the server via the connection 13 and display the web page constructed from the web page information on the display 23. The user provides input via input unit 25, which the processing unit converts into responses for the web server 11.

The electronic telephone circuit 22 and the processing unit 24 are completely independent and any interaction is indirect via the web server 11 end the telephone switch 5. The browser application executed on the processing unit 24 can be used for other purposes as well since it is a standard web browser without any special application related features. The processing unit 24 can be optimized for running the browser application and thus a cheap browser to access other web servers on the network can be provided to the user of a telephone.

The browser can be used for signalling purposes between the telephone and the telephone switch. Dialing can be effected by transferring dial information from the browser via the webserver and the control application to the telephone switch. An incoming call can be signalled to the telephone by flashing a message on a web page, sending a corresponding HTTP command, or embedding a sound in a web page.

FIG. 3 shows a telephone according to the present invention where the browser is used both for control of the telephone switch and the plain telephone functions.

The telephone 30 comprises a speaker 36, a microphone 38, and a regular electronic telephone circuit 32. The electronic telephone circuit 32 to interface the speaker 36, the microphone 38 and the keypad 31 to a telephone line 37 is very well known from the prior art. The telephone 30 further comprises a processing unit 34 that can run a browser program. The processing unit 34 displays information on a display 33 and receives input from the user from an input unit 35. The input unit 35 can be based on voice recognition, touch screen technology or a keyboard. The processing unit processes the web page information received from the web server 11 via the connection 39 and display the web page constructed from the web page information on the display 33. The user provides input via input unit 35, which the processing unit converts into responses for the web server 11.

The electronic telephone circuit 32 is controlled by a control application that is executed on the processing unit 34. The interaction between the browser and the telephone can be either indirect via the web server 11 and the telephone switch 5 or directly via a connection 40 between the processing unit 34 and the electronic telephone circuit 32. The browser program running on the processing unit 34 can be used for other purposes as well since it is a standard web browser without any special application related features. The processing unit 34 can be optimized for running the browser application and thus a cheap browser to access other web servers on the network can be provided to the user of a telephone.

The browser can be used for signalling purposes between the telephone and the telephone switch. Dialing can be effected by transferring dial information from the browser via the web server and the control application to the telephone switch. An incoming call can be signalled to the telephone by flashing a message on a web page, sending a corresponding HTTP command, or embedding a sound in a web page.

The connection between the processing unit 34, executing the browser application, and the electronic telephone circuit 32 allows the processing unit to directly control the telephone's functions including the signalling functions, thus using the regular DTMF tones for dialing and the regular ringer of the telephone for signalling an incoming call.

FIG. 4 shows a web page to control the telephone switch.

One of the functions of the telephone switch that can be controlled is activating a remote extension. This remote extension is a remote telephone that is not directly connected to the telephone switch, but a connection can be established through the Public Switched Telephone Network. When the remote extension is activated telephone calls to the user will be routed to the remote telephone by first establishing a connection, for instance by dialing the remote telephone's number and then switching the call to the connection once the connection is established. When the remote extension is de-activated the telephone call is routed directly to the telephone at the user's local extension.

To control the remote extension function a web page 41 as shown in FIG. 4 is used.

The web page 41 displays some information about the extension. It shows the extension number 42, and the status 43 of the extension. The information about the extension 42, 43 is obtained from the telephone switch and is used by the web server to generate the web page 41.

To change the routing of calls from the local extension to the remote extension a remote extension button 44 is provided. By pressing this button the telephone switch is instructed to switch between routing to the local extension and routing to the remote extension.

To obtain information about the percentage of telephone calls answered an answering statistics button 45 is provided. By pressing this button the web server passes a request for information to the control application, which in turn instructs the telephone switch to provide information about the percentage of telephone calls that were answered.

The telephone switch provides this information to the control application, which in turn provides the information to the web server. The webserver then sends a web page containing the information in a standardized format to the browser, where it is displayed for use by the user.

To disable the extension completely a deactivation button 46 is provided. By pressing this deactivation button 46 the user effectively logs off from the web server and instructs the web server to stop passing status info back.

FIG. 5 shows a web page to retrieve information from the telephone switch.

When working in a group it is very useful to have information about colleagues in the group. The telephone switch has information about the extensions of colleagues, for instance whether the extension is deactivated, or whether the extension is a remote extension or a local extension currently. This provides information about whether the colleague is working remotely or locally, and whether he is present or absent. Since web page 50 shows the name 51 of the group, the status of the extensions are represented by icons 52, 53, 54. If the colleague is absent the icon 52, 53, 54 shows the backside of a person, while if the colleague is present the front of a person will be shown. In FIG. 5 the colleagues at extensions 2303 and 2401 are absent, while the colleague of extension 2304 is present. By showing an icon where a person is holding a telephone hook next to his ear it is indicated that the colleague's extension is currently being used.

Using different icons it is possible to indicate the status of extensions in a very user-friendly fashion, while still allowing a regular telephone to be used for the actual communication.

FIG. 6 shows the communication system according to the present invention where control of the telephone switch is provided to a plain telephone located in a remote location.

The telephone 67 is connected via a telephone line 65 and through the Public Switched Telephone Network 63 and via a telephone line 61 between the Public Switched Telephone Network 63 and the telephone switch 68 to the telephone switch 68. The telephone switch 68 is connected to other telephones via a telephone line 71.

The server 72 can control the telephone switch 68 via connection 70. The browser 69 functions as a user interface and is connected via connection 66 to the Internet 64 or a private network, for instance an intranet. The browser can establish a connection with the server 72 because the server 72 is also connected to the Internet 64 or the private network via connection 62. The user can access the web server 72 through the browser 69. The web server 72 provides an address where a web page can be found to the browser 69, the browser 69 then retrieves that web page from the specified address and displays the contents of the web page. The web page can contain a menu or buttons or a form or any combination thereof. The content of the web page is determined by the web server 72 and the telephone switch 68, based on how the telephone switch 68 operates and the features it provides for the user.

When the user provides information to the web server 72 by operating a button, selecting an item from a menu, or by completing a form, the web server 72 transfers this information to a control application that, based on the received information, send the appropriate control commands to the telephone switch 68. This can be used for instance, to change the status of the telephone user from local to remote as described in FIG. 4.

1. Communication system comprising a telephone, a telephone switch operative to interact with the telephone and provide a control function to a user of the telephone, characterized in that the communication system comprises a web server connected to the telephone switch, where the web server is operative to provide the control function to the user of the telephone via an HTTP client application connected to the web server.

2. Communication system according to claim 1,
characterized in that the web server is operative to provide the control function to the user via a URL.

3. Communication system according to claim 2,
characterized in that a web page is associated with the URL.

4. Communication system according to claim 3,
characterized in that the web page comprises an element to implement the control function.

5. Communication system according to claim 3 or 4,
characterized in that the web page is associated with the telephone.

6. Communication system according to claim 3 or 4,
characterized in that the web page is associated with the user of the telephone.

7. Communications system according to claim 1, 2, or 3
characterized in that the telephone comprises the HTTP client application.

8. Communication system according to claim 5,
characterized in that the web page can only be accessed from a HTTP client application in close proximity to the telephone.

9. Communication system according to claim 5,
characterized in that the web page comprises a signaling function for the telephone.

10. Communication system according to claim 5,
characterized in that the web page comprises a signaling function for the telephone switch.

11. Communication system according to claim 9, or 10,
characterized in that the signaling function is implemented in the application layer.

12. Telephone for use with a communication system according to claim 7,.

13. Web page for use with a communication system according to any of the claims 1 to 12.

14. Telephone switch for use with a communication system according to any of the claims 1 to 12.

15. Webserver for use with a communication system according to any of the claims 1 to 12.

16. Method for providing a control function to a user of a communication system comprising the following steps:
providing a web page to a HTTP client application,
obtaining control information related to this web page from the HTTP client application
passing the control information to a control application
processing the control information by the control application to create a control command
passing the control command to a telephone switch
processing the control command by the telephone switch.
